(19) United States
(12) Patent Application Publication
(10) Pub. No.: US 2018/0227897 A1
(43) Pub. Date: Aug. 9, 2018

(54) METHOD AND DEVICE FOR TRANSMITTING NARROW BAND SIGNAL IN WIRELESS CELLULAR COMMUNICATION SYSTEM

(71) Applicant: Samsung Electronics Co., Ltd., Gyeonggi-do (KR)

(72) Inventors: Jeongho YEO, Gyeonggi-do (KR); Juho LEE, Gyeonggi-do (KR); Jinkyu HAN, Gyeonggi-do (KR); Donghan KIM, Gyeonggi-do (KR)

(21) Appl. No.: 15/746,993

(22) PCT Filed: Jul. 25, 2016
(86) PCT No.: PCT/KR2016/008103

§ 371 Date: Jan. 23, 2018

Related U.S. Application Data
(60) Provisional application No. 62/195,954, filed on Jul. 23, 2015.
(60) Provisional application No. 62/200,320, filed on Aug. 3, 2015.

(51) Int. Cl. H04W 72/04

(52) U.S. Cl. CPC H04W 72/0406

(57) ABSTRACT

The present disclosure relates to a communication method and system for converging a 5^{th}-Generation (5G) communication system for supporting higher data rates beyond a 4^{th}-Generation (4G) system with a technology for Internet of Things (IoT). The present disclosure may be applied to intelligent services based on the 5G communication technology and the IoT-related technology, such as smart home, smart building, smart city, smart car, connected car, health care, digital education, smart retail security and safety services. In particular, the present disclosure relates to a wireless communication system and, more particularly, to a method and device for transmitting or receiving a synchronization signal, a physical broadcast channel, a control signal, and a data signal in a system supporting transmission and reception through a narrowband channel of about 180 kHz. Specifically, the present disclosure defines an in-band mode operation of an LTE-lite terminal in order to avoid collision with a conventional LTE terminal, and provides a method for using a reference signal, a method for periodically puncturing a specific slot, and so on.

### TECHNICAL FIELD

Various embodiments of the present disclosure relate to a wireless communication system, and more particularly, to, a method and device for transmitting and receiving a signal using a narrow band.

### BACKGROUND ART

To meet the demand for wireless data traffic having increased since deployment of 4G communication systems, efforts have beers made to develop an improved 5G or pre-5G communication system. Therefore, the 5G or pre-5G communication system is also called a ‘Beyond 4G Network’ or a ‘Post LTE System’. The 5G communication system is considered to be implemented m higher frequency (mm Wave) bands, e.g., 60 GHz bands, so as to accomplish higher data rates. To decrease propagation loss of the radio waves and increase the transmission distance, the beamforming, massive multiple-input multiple-output (MIMO), Full Dimensional MIMO (FD-MIMO), array antenna, an analog beam forming, large scale antenna techniques are discussed in 5G communication systems. In addition, in 5G communication systems, development for system network improvement is under way based on advanced small cells, cloud Radio Access Networks (RANs), ultra-dense networks, device-to-device (D2D) communication, wireless backhaul, moving network, cooperative communication, Coordinated Multi-Points (CoMP), reception-end interference cancellation and the like. In the 5G system, Hybrid FSK and QAM Modulation (FQAM) and sliding window superposition coding (SWSC) as an advanced coding modulation (ACM), and filter bank multi earlier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication. Machine Type Communication (MTC), and so forth have been recently researched. Such an IoT environment may provide intelligent internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

In line with this, various attempts have been made to apply 5G communication systems to IoT networks. For example, technologies such as a sensor network, Machine Type Communication (MTC), and Machine-to-Machine (M2M) communication may be implemented by beamforming, MIMO, and array antennas. Application of a cloud Radio Access Network (RAN) as the above-described Big Data processing technology may also be considered to be as an example of convergence between the 5G technology and the IoT technology.

In recent years, to provide the Internet-of-things (Iot) service, a communication system using a communication module winch is cheap and has much less power consumption has been required. In particular, to be operated in the LTE system and to transmit/receive signals using only a narrow band such as 1 physical resource block (1 PRB), there is a need to define transmission/reception operations differentiated from normal LTE and LTE-A terminals.

### DISCLOSURE

### Technical Problem

Therefore, in the cellular system supporting the terminal operated in such a narrow band, there is a need to distinguish whether the frequency band in which the corresponding terminals are operated is a frequency band in which existing LTE and LTE-A terminals exist or a frequency band independent of the conventional LTE and LTE-A systems. That is, a method of distinguishing whether the narrow band communication system is an in-band mode or a stand-alone mode is needed. In addition, in order that the normal LTE and LTE-A terminals and the terminal operated in the narrow band are operated together in the same system, there is a need to define an additional operation required for the terminal (hereinafter, interchangeably used with an LTE-lite terminal) operated in the narrow band.

An object of the present disclosure is directed to the provision of a method and device for causing an LTE-lite terminal to distinguish between an in-band mode and a stand-alone mode and a method and device for operating an LTE-lite terminal so that the LTE-lite terminal is operated along with normal LTE and LTE-A terminals when being operated in an in-band mode.

### Technical Solution

Various embodiments of the present disclosure are directed to the provision of a method for transmitting/receiving a signal of a base station in a wireless communication system including: determining whether an LTE-lite terminal is operated in any of an in-band mode and a stand-alone mode; generating synchronization signals for the LTE-lite terminal according to the determined mode; and transmitting the generated synchronization signal. A part of the synchronization signals may be changed according to the in-band mode or the stand-alone mode.

Various embodiments of the present disclosure are directed to the provision of a method for transmitting/receiving a signal of a base station in a wireless communication system including: identifying whether an LTE-lite system is in an in-band mode and a stand-alone mode; differently generating synchronization signals according to the identified mode; and transmitting the generated synchronization signal in a frequency band in which the LTE-lite terminal exists.

Various embodiments of the present disclosure are directed to the provision of a method for transmitting/receiving a signal of a base station in a wireless communication system including: identifying a PRB index in which an LTE-lite system operated in an in-band mode exists in a specific PRB in the conventional LTE system and the conventional LTE system bandwidth; identifying m′ among CRS-related parameters; converting the identified information in bits in a binary number; and transmitting the converted information to a PBCH-lite for an LTE-lite.

Various embodiments of the present disclosure are directed to the provision of a method for transmitting/receiving a signal of an LTE-lite terminal in a wireless communication system including: identifying a PRB index in which an LTE-lite system operated in an in-band mode exists in a specific PRB in the conventional LTE system and the conventional LTE system bandwidth from a signal on a PBCH-lite; identifying m′ among CRS parameters from a signal on the PBCH-lite; and finding a location and a value of CRS used in the conventional LTE system using the previously identified information.

Various embodiments of the present disclosure are directed to the provision of a method for transmitting/receiving a signal of a base station in a wireless communication system including: transmitting a PBCH-lite at the same timing in two LTE-lite systems when at least two LTE-lite systems operated in an in-band mode exist in specific PRBs in the conventional LTE system.

Various embodiments of the present disclosure are directed to the provision of a method for transmitting/receiving a signal of a base station in a wireless communication system including: transmitting a PBCH-lite when timing is not the same in two LTE-lite systems when at least two LTE-lite systems operated in an in-band mode exist in specific PRBs in the conventional LTE system. More specifically, for example, a difference between the two PBCH-lite transmission timings in the two LTE-lite systems may be an integer multiple of 10 ms.

Various embodiments of the present disclosure are directed to the provision of a method of transmitting/receiving a signal of a base station in a wireless communication system including: configuring control and data signals or the like not to be transmitted in a specific slot; transmitting the configuration information in a physical channel to which system information such as a PBCH-lite is transmitted; and not transmitting the control and data signals in the corresponding slot.

Various embodiments of the present disclosure are directed to the provision of a method for transmitting, by a base station, a control signal to a terminal including: identifying, by the base station, a PRB index of a physical resource block (PRB) in which a narrow band LTE system is located; and transmitting information related to the PRB index to the terminal, in which the PRB index is a PRB index of an LTE system. The in formation related to the PRB index may be 5 bits, the narrow band LTE system may be an in-band system, and the information related to the PRB index may be transmitted to a physical broadcast channel.

Various embodiments of the present disclosure are directed to the provision of a method for receiving, by a terminal, a control signal from a base station including: receiving information related to a PRB index of a physical resource block (PRB) in which a narrow band LTE system is located; and identifying the PRB index based on the information related to the PRB index, in which the PRB index is a PRB index of an LTE system.

Various embodiments of the present disclosure are directed to the provision of a base station transmitting a control signal to a terminal including: a transceiver configured to transmit and receive a signal to and from the terminal; and a controller configured to control to identify a PRB index of a physical resource block (PRB) in which a narrow band LTE system is located and transmit information related to the PRB index to the terminal, in which the PRB index is a PRB index of an LTE system.

Various embodiments of the present disclosure are directed to the provision of a terminal receiving a control signal from a base station including: a transceiver configured to transmit and receive a signal to and from the base station; and a controller configured to control to receive information related to a PRB index of a physical resource block (PRB) in which a narrow band LTE system is located and identify the PRB index based on the information related to the PRB index, in which the PRB index is a PRB index of an LTE system.

### Advantageous Effects

As described above, the present disclosure provides the method of distinguishing between the in-band mode and the stand-alone mode by the LTE-lite synchronization method and provides the additional operation for the in-band mode, such that the existing terminal and the LTE-lite terminal can efficiently coexist within the system.

### BRIEF DESCRIPTION OF THE DRAWINGS

FIG. 1 is a diagram illustrating a basic structure of a time-frequency domain that is a radio resource region in which data or a control channel is transmitted on a downlink in an LTE system.

FIG. 2 is a diagram illustrating an example of a time-frequency domain transmission structure of a PUCCH in an LTE-A system according to the related art.

FIG. 3 is a diagram illustrating an example in which PSS, SSS, and PBCH are transmitted in the LTE system.

FIG. 4A is a diagram illustrating an uplink frame structure in an LTE or LTE-A system, respectively.

FIG. 4B is a diagram illustrating a frame structure that may be used in a downlink and an uplink of LTE-lite.

FIG. 5A is a diagram illustrating a 1 PRB pair of the time-frequency domain which is the radio resource region in which the data or the control channel is transmitted on the downlink in the LTE system.

FIG. 5B is a diagram illustrating a slot structure of the LTE-lite along with an OFDM symbol and a CP length, when 1 PRB is used in an LTE-lite system in a normal CP mode of the conventional LTE system.

FIG. 5C is a diagram illustrating the slot structure of the LTE-lite along with the OFDM symbol and the CP length, when 1 PRB (548) is used in the LTE-lite system in an extended CP mode of the conventional LTE system.

FIG. 5D is a diagram illustrating the slot structure of the LTE-lite system using 1 PRB 568 along with the OFDM symbol and the CP length.

FIG. 6 is a diagram illustrating a process in which an LTE-lite base station generates a sequence to transmit a synchronization signal to an LTE-lite terminal and transmits an SSS.

FIG. 7 is a diagram illustrating an operation of identifying whether the LTE-lite system is in an in-band mode or a stand-alone mode in a process of receiving and decoding an SSS by the LTE-lite terminal.

FIG. 8 is a diagram illustrating a frequency-time resource in which the LTE-lite system is operated in the in-band mode at 1 PRB in a frequency band in which the conventional LTE and LTE-A systems exist.

FIG. 9A is a diagram illustrating a process in which the LTE-lite base station transmits information on which PRB is operated in the conventional LTE system by including the information in a PBCH-lite.

FIG. 9B is a diagram illustrating a method of transmitting CRS-related information of the conventional LTE system by including the CRS-related information in the PBCH-lite.

FIG. 10 is a diagram illustrating a process in which the LTE-lite system identifies information on how many PRBs the corresponding frequency domain is located at, in conventional LTE system when being operated in the in-band mode or the LTE-lite terminal identities the CRS-related information of the conventional LTE system from the PBCH-lite.

FIG. 11 is a diagram illustrating a resource in a conventional LTE system bandwidth.

FIG. 12 is a diagram illustrating a process of identifying a CRS value on a PRB where the LTE-lite system is located using the information included in the PBCH-lite after PBCH-lite decoding when the LTE-lite system is operated in the in-band mode.

FIG. 13 is a diagram illustrating a method for operating the LTE-lite system at two or more PRBs within the conventional LTE system bandwidth.

FIG. 14 is a diagram illustrating another method for operating the LTE-lite system at two or more PRBs within the conventional LTE system bandwidth.

FIG. 15 is a diagram illustrating a puncturing process in which the LTE-lite base station does not periodically transmit control and data signals in a specific slot when transmitting the control and data signals to the LTE-lite terminal.

FIG. 16 is a diagram illustrating a process in which the LTE-lite terminal does not periodically receive the control and data signals in a predetermined specific slot (i.e., a punctured slot) when receiving a signal from the LTE-lite base station.

FIG. 17 is a block diagram illustrating an internal structure of a terminal according to an embodiment of the present disclosure.

FIG. 18 is a block diagram illustrating an internal structure of a base station according to the embodiment of the present disclosure.

### BEST MODE

A wireless communication system has been developed from a wireless communication system providing a voice centered service in the early stage toward broadband wireless communication systems providing high-speed, high-quality packet data services, such as communication standards of high speed packet access (HSPA) and long term evolution (LTE) or evolved universal terrestrial radio access (E-UTRA) of the 3GPP, high rate packet data (HRPD) and ultra mobile broadband (UMB) of 3GPP2, 802.16e of IEEE or the like. Hereinafter, the LTE and the LTE-A are interchangeably used.

As a representative example of the broadband wireless communication system, the LTE system has adopted an orthogonal frequency division multiplexing (OFDM) scheme in a downlink (DL) and has adopted a single carrier frequency division multiple access (SC-FDMA) scheme in an uplink (UL). The uplink refers to a radio link through which a user equipment (UE) or a mobile station (MS) transmits data or a control signal to a base station (eNodeB or base station (BS)) and the down link refers to a radio link through which a base station transmits data or a control signal to a terminal. The multiple access scheme as described above normally assigns and operates time-frequency resources including data or control information to be transmitted to each other to prevent the time-frequency resources from overlapping with each other, that is, establish orthogonality, thereby distinguishing the data or the control information of each user.

If a decoding failure occurs upon initial transmission, the LTE system has adopted a hybrid automatic repeat reQuest (HARQ) scheme of retransmitting the corresponding data in a physical layer. If a receiver does not accurately decode data, the HARQ scheme enables the receiver to transmit information (negative acknowledgement (NACK)) informing the decoding failure to a transmitter to thereby enable the transmitter to retransmit the corresponding data in the physical layer. The receiver combines the data retransmitted by the transmitter with the data that fails to previously decode, thereby increasing reception performance of the data. Further, if the receiver accurately decodes the data, information (acknowledgement (ACK)) notifying a decoding success is transmitted to the transmitter so that the transmitter may transmit new data.

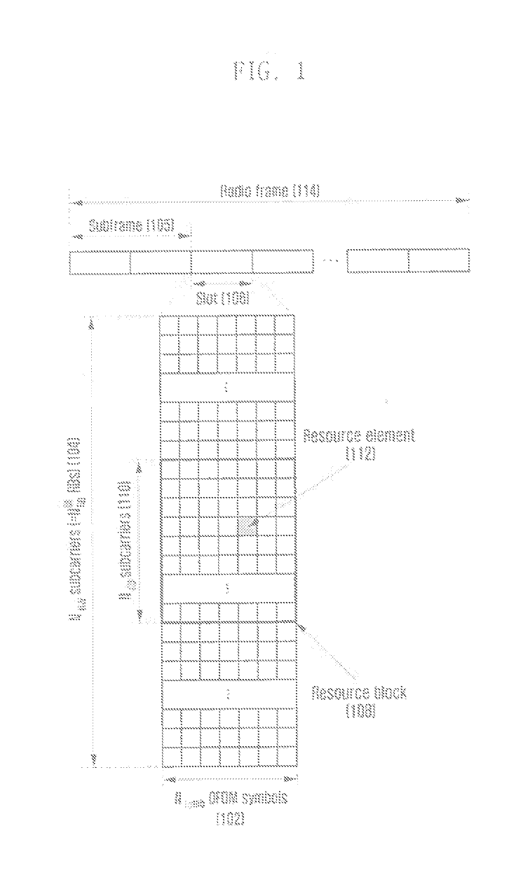

FIG. 1 is a diagram illustrating a basic structure of a time-frequency domain that is a radio resource region in which data or a control channel is transmitted on a downlink in an LTE system.

In FIG. 1, an abscissa represents a time domain and an ordinate represents a frequency domain. A minimum transmission unit in the time domain is an OFDM symbol, in which Nsymb OFDM symbols 102 are gathered to form one slot 105 and two slots are collected to one subframe 105. The slot length is 0.5 ms and the subframe length is 1.0 ms. A radio frame 114 is a time domain interval including 10 subframes. A minimum transmission unit in a frequency domain is a sub-carrier, in which the entire system transmission bandwidth includes a total of NBW sub-carriers 104.

A basic unit of resources in the time-frequency domain is a resource element (RE) 112 and may be represented by an OFDM symbol index and a sub-carrier index. A resource block (RB) 108 (or physical resource block (PRB)) is defined by the Nsymb continued OFDM symbols 102 in the time domain and NRB continued sub-carriers 110 in the frequency domain. Therefore, one RE 108 includes Nsymb×NRB REs 112. In general, a minimum transmission unit of the data is the RB unit. In the LTE system, generally, Nsymb=7 and NRB=12 and NBW and the number of NRB are proportional to the system transmission bandwidth. A data rate is increased in proportion to the number of RBs scheduled for the terminal. The LTE system is operated by defining six transmission bandwidths. In an FDD system operated by dividing the downlink and the uplink based on a frequency, a downlink transmission bandwidth and an uplink transmission bandwidth may be different from each other. A channel bandwidth represents an RF bandwidth corresponding to the system transmission bandwidth. The following Table 1 shows a correspondence relationship between the system transmission bandwidth and the channel bandwidth that are defined in the LTE system. For example, the LTE system having the channel bandwidth of 10 MHz is configured of a transmission bandwidth including 50 RBs.

TABLE 1

| | Channel bandwidth | | | | | |
|---|---|---|---|---|---|---|
| | BW_{Channel} [MHz] | | | | | |
| | 1.4 | 3 | 5 | 10 | 15 | 20 |
| Transmission bandwidth configuration | 6 | 15 | 25 | 50 | 75 | 100 |
| N_{RB} | | | | | | |

The downlink control information is transmitted within first N OFDM symbols within the subframe. In general, N={1, 2, 3}. Therefore, the N value varies in each subframe depending on the amount of control information to be transmitted at the current subframe. The control information may include a control channel transmission interval indicator representing over how many OFDM symbols the control information is transmitted, scheduling information on downlink data or uplink data, HARQ ACK/NACK signals, or the like.

In the LTE system, the scheduling information on the downlink data or the uplink data is transmitted from a base station to a terminal through downlink control information (DCI). The DCI defines various formats, and thus applies and operates a DCI format defined depending on whether the DCI is the scheduling information (uplink (UL) grant) on the uplink data and the scheduling information (downlink (DL) grant) on the downlink data, whether the DCI is compact DCI having a small size of control information, whether the DCI applies spatial multiplexing using a multiple antenna, whether the DCI is DCI for a power control, or the like. For example, DCI format 1 that is the scheduling control information (DL grant) on the downlink data is configured to include at least following control information.
Resource allocation type 0/1 flag: It is notified whether a resource assignment scheme is type 0 or type 1. The type 0 applies a bitmap scheme to assign a resource in a resource block group (RBG) unit. In the LTE system, a basic unit of the scheduling is the resource block (RB) represented by a time-frequency domain resource and the RBG includes a plurality of RBs and thus becomes a basic unit of the scheduling in the type 0 scheme. The type 1 assigns a specific RB within the RBG.
Resource block allocation: The RB assigned for the data transmission is notified. The represented resource is determined depending on the system bandwidth and the resource allocation scheme.
Modulation and coding scheme (MCS): The modulation scheme used for the data transmission and a size of a transport block that is the data to be transmitted are notified.
HARQ process number: An HARQ process number is notified.
New data indicator: An HARQ initial transmission or retransmission is notified.
Redundancy version: An HARQ redundancy version is notified.
Transmit power control command for physical uplink control channel (PUCCH): A transmit power control command for the PUCCH that is an uplink control channel is notified.

The DCI is subjected to a channel coding and modulation process and then is transmitted on a physical downlink control channel (PDCCH) (or control information, which is interchangeably used below) or an enhanced PDCCH (EPDCCH) (or enhanced control information, which is interchangeably used below).

In general, each DCI is independently scrambled with a specific radio network temporary identifier (RNTI) (or a terminal identifier) for each terminal to be added with a cyclic redundant check (CRC), subjected to channel coding, and then configured of independent PDCCH to be transmitted. In the time domain, the PDCCH is mapped and transmitted during the control channel transmission period. A mapping location in the frequency domain of the PDCCH is determined by identifiers IDs of each terminal and is spread over the entire system transmission bandwidth.

The downlink data are transmitted on a physical downlink shared channel (PDSCH). The PDSCH is transmitted after the control channel transmission interval and the PCI transmitted on the PDCCH informs the scheduling information on the detailed mapping location in the frequency domain, the modulation scheme, or the like.

By the MCS including 5 bits among the control information configuring the DCI, the base station notifies the modulation scheme applied to the PDSCH to be transmitted to the terminal and a data size (transport block size (TBS)) to be transmitted. The TBS corresponds to a size before channel coding for error correction is applied to data (transport block (TB)) to be transmitted by a base station.

The modulation scheme supported in the LTE system is quadrature phase shift keying (QPSK), 16 quadrature amplitude modulation (QAM), and 64 QAM, in which each modulation order Qm corresponds to 2, 4, and 6. That is, in the case of the QPSK modulation, 2 bits per symbol may be transmitted, in the case of the 16 QAM modulation, 4 bits per symbol may be transmitted, and in the case of the 64 QAM modulation, 6 bits per symbol may be transmitted.

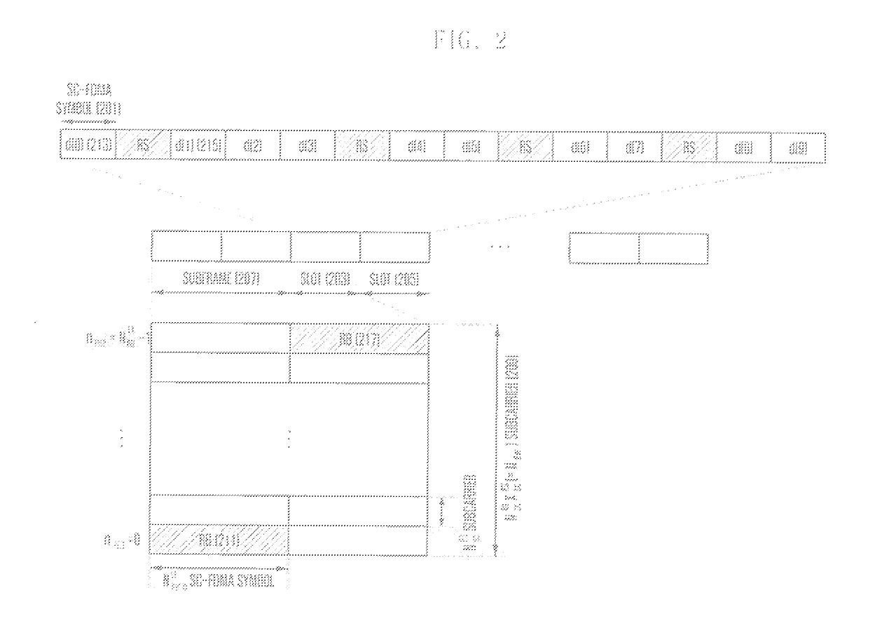

FIG. 2 is a diagram illustrating an example of a time-frequency domain transmission structure of a PUCCH in an LTE-A system according to the related art. In other words, FIG. 2 illustrates a time-frequency domain transmission structure of the physical uplink control channel (PUCCH) which is a physical control channel on which the terminal transmits uplink control information (UCI) to the base station in the LTE-A system.

The UCI includes at least one of the following control information.
HARQ-ACK: The terminal feedbacks acknowledgment (ACK) from the base station if there is no error in reception of the PDCCH about a downlink data or a semi-persistent scheduling (SPS) release which is received on the physical downlink shared channel (PDSCH) which is a downlink data channel to which a hybrid automatic repeat request (HARQ) is applied and feedbacks negative acknowledgment if there is an error in reception.
Channel status information (CSI): It includes a signal indicating a channel quality Indicator (CQI), a preceding matrix indicator (PMI), a rank indicator (RI), or a downlink channel coefficient. The base station sets a modulation and coding scheme (MCS) or the like for data which is to be transmitted to the terminal from the CSI obtained from the terminal to an appropriate value and satisfies predetermined reception performance for the data. The CQI represents a signal to interference and noise ratio (SINR) for a system wideband or a subband. In general, the CQI is represented in a form of the MCS for satisfying predetermined data reception performance. The PMI/RI provides preceding and rank information necessary for a base station to transmit data through multiple antennas in a system supporting multiple input multiple output (MIMO). The signal indicating the downlink channel coefficient provides relatively detailed channel status information than the CSI signal, but has a problem of increasing an uplink overhead. Here, the terminal is specifically notified in advance CSI configuration information on a reporting mode indicating which information is to be fed back, resource information on which resource is used, a transmission period, and the like from the base station through higher layer signaling. Then, the terminal transmits the CSI to the base station using the CSI configuration information notified in advance.

Referring to FIG. 2, an abscissa represents a time domain and an ordinate represents a frequency domain. The minimum transmission unit in the time domain is an SC-FDMA symbol 201, and the NsymbUL SC-FDMA symbols are gathered to form one slot 203 and 205. Two slots are gathered to form one subframe 207. The minimum transmission unit in the frequency domain is a subcarrier, in which the entire system transmission bandwidth 209 includes a total of NBW subcarriers. The NBW has a value in proportion to the system transmission bandwidth.

A basic unit of resources in the time-frequency domain is a resource element (RE) and may be defined as an SC-FDMA symbol index and a sub-carrier index. Resource blocks (RBs) 211 and 217 are defined as NsymbUL continued SC-FDMA symbols in the time domain and NscRB continued subcarriers in the frequency domain. Accordingly, one RB includes NsymbUL×NscRBREs. In general, the minimum transmission unit of the data or the control information is the RB unit. The PUCCH is mapped to a frequency domain corresponding to 1 RB and transmitted for one subframe.

FIG. 2 illustrates an example in which NsymbUL=7, NscRB=12, and the number NRSPUCCH of reference signals (RS) for channel estimation within one slot is 2. The RS uses a constant amplitude zero auto-correlation (CAZAC) sequence. The CAZAC sequence has a feature that signal intensity is constant and an autocorrelation coefficient is zero. A newly configured CAZAC sequence is maintained in mutual orthogonality to an original CAZAC sequence by cyclically shifting a predetermined CAZAC sequence by a value larger than a delay spread of a transmission path. Accordingly, a CS-CAZAC sequence in which up to L orthogonality is maintained may be generated from a CAZAC sequence having length L. The length of the CAZAC sequence applied to the PUCCH is 12 which corresponds to the number of subcarriers configuring one RB.

The UCI is mapped to the SC-FDMA symbol to which the RS is not mapped. FIG. 2 illustrates an example in which a total of 10 UCI modulation symbols 213 and 215 (d (0), d (1), . . . , d (9)) are mapped to each of the SC-FDMA symbols within one subframe. Each UCI modulation symbol is mapped to a SC-FDMA symbol alter being multiplied by a CAZAC sequence applied with a predetermined CS value for multiplexing with UCI of another terminal The PUCCH is applied with frequency hopped in a slot unit to obtain frequency diversity. The PUCCH is located outside a system transmission band and enables data transmission in the remaining transmission bands. That is, the PUCCH is mapped to the RB 211 located at an outermost of the system transmission band in a first slot in the subframe, and is mapped to the RB 217 which is a frequency domain different from the RB 231 located at another outermost of the system transmission band in a second slot in the subframe. In general, RB locations where the PUCCH for transmitting HARQ-ACK and the PUCCH for transmitting CSI are mapped do not overlap with each other.

In the LTE system, the terminal uses a primary synchronization signal (PSS) and a secondary synchronization signal (SSS) to synchronize with the base station. In a system operated in FDD, the PSS is transmitted in a last OFDM symbol of each slot 0 and each slot 10. In an interval of the middle 6 PRBs corresponding to about 1.04 MHz of the entire frequency domain. Meanwhile, in the system operated in the FDD, the SSS is transmitted in a second OFDM symbol to the last of each slot 0 and each slot 10, in an interval of the middle 6 PRBs corresponding to about 1.04 MHz of the entire frequency domain. The terminal receives system information from a physical broadcast channel (PBCH) after receiving the PSS and the SSS. The PBCH of the LTE system includes the following information.
System bandwidth: The system bandwidth is notified by one of 1.4, 3, 5, 10 15, 20 MHz using 3 bits.
Physical HARQ indicator channel (PHICH) information: The configuration information related to the PHICH is notified using 3 bits.
System frame number (SFN): 8 bits of system frame number 10 bits are notified using 8 bits.

If the decoding of the PSS and the SSS is successful, the terminal can know cell IDs from 0 to 503, and know a slot number and a frame boundary during the decoding of the SSS. It is possible to know a location and a value of a cell specific reference signal (CRS) based on the information. Here, the known CRS can be used for the PBCH decoding.

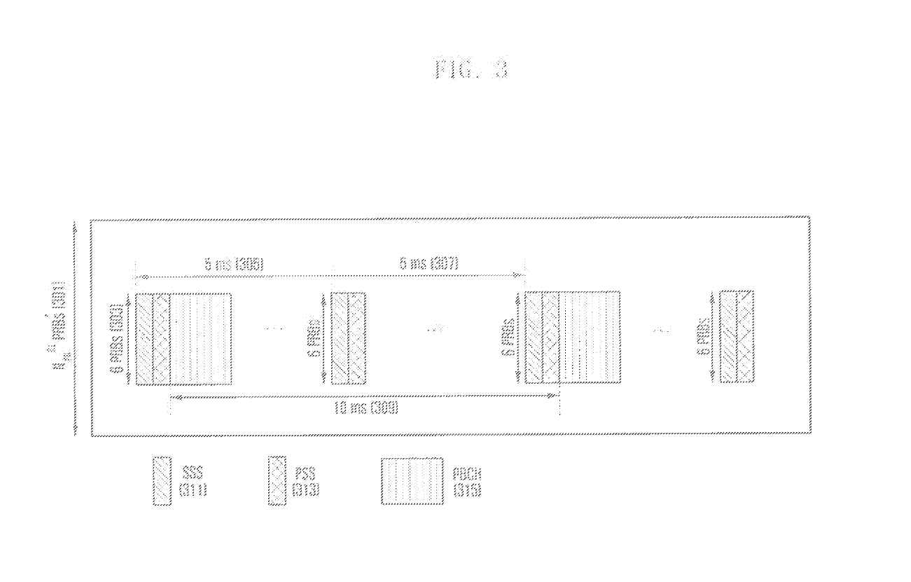

FIG. 3 is a diagram illustrating an example in which PSS, SSS, and PBCH are transmitted in the LTE system. A PSS 313, a SSS 311 and a PBCH 315 are transmitted only in the middle 6 PRBs 303 regardless of a system bandwidth 301. The PSS and the SSS are transmitted (305, 307) every 5 ms, and the PBCH is transmitted every 10 ms. The PBCH is transmitted (309) every 30 ms, but since the same PBCH is repeated four times, the PBCH is updated every 40 ms and transmitted.

Meanwhile, in addition to the wideband wireless communication system that provides high-speed and high-quality packet data services, recently, to provide the Internet-of-Things (IOT) service, the communication system using the communication module that is inexpensive and consumes much less power is required. Specifically, low price of $1 to $2 per communication module, low power consumption that may be operated for 10 years with one AA size battery, or the like are required. In addition, for metering of water, electricity, and gas using the IoT communication module, the coverage of the IoT communication module should be wider than that of current cellular communication.

In the GERAN technical specification group of the 3GPP, standardization for providing a cellular-based IoT service using the conventional GSM frequency channel is under way. In the RAN technical specification group, standardization for a machine type communications (MTC) terminal operated on the LTE basis is under way. Both technologies support implementation of a cheap communication module and support a wide range of coverage. However, the MTC terminal operated based on the LTE is still expensive and has a short battery life. Therefore, it is expected that a new transmission/reception technique is needed for the terminal (hereinafter, IoT terminal) for providing the cellular-based IoT service.

In particular, network operators who operate the LTE will want to require a minimum additional cost even if they support IoT equipment. In particular, transmission/reception techniques capable of minimizing the change in the conventional LTE base station and supporting the low cost, low power IoT equipment without interfering with the conventional LTE terminal are required.

In the current LTE and LTE-A systems, the terminal should be able to receive a signal in the frequency domain of at least 6 PRBs to be operated within the LTE system. This is closely related to the PSS, SSS, and PBCH reception described above. The 6 PRBs corresponds to a frequency bandwidth of 1.08 MHz. Accordingly, it is impossible to use the conventional LTE system and terminal structure in a narrow band wireless channel of 180 kHz or 200 kHz.

Therefore, it is necessary to define a transmission/reception operation differentiated from the normal LTE and LTE-A terminals in order to be able to enable the signal transmission/reception using only a narrow band such as 1 PRB while being operated within the LTE system. Accordingly, the present disclosure proposes a detailed method for operating the normal LTE and LTE-A terminals and the narrow band terminal together in the same system.

The narrow band terminals may be operated in the LTE and LTE-A system, but is not limited only to the LTE system. Therefore, the narrow band terminals may be independently operated in narrow band channels such as 180 kHz or 200 kHz. The frequency bandwidth need not be accurately 180 kHz and 200 kHz and may be operated in a frequency bandwidth larger than 180 kHz.

The narrow band terminal may be called an LTE-lite terminal a narrow band terminal, a cellular IoT terminal, or a narrow band IoT (NB-IoT) terminal in the present disclosure. In general, the LTE and LTE-A terminals and the LTE-lite terminal may be operated together in the same system. In this case, according to the present disclosure, the LTE-lite may be called an in-band mode. Meanwhile, the LTE-lite terminal may be operated in an independent bandwidth of 180 kHz or more. In this case, according to the present disclosure, the LTE-lite may be called a stand-alone mode.

In the present disclosure, a system operating the LTE-lite terminal is called the LTE-lite system (or a narrow band LTE system). There may be the LTE-lite in the stand-alone mode operating the LTE-lite terminal regardless of the LTE-lite system and the LTE system in the in-band mode in which the LTE-lite terminal is operated in the frequency band in which the conventional LTE and LTE-A terminal exist. The LTE-lite system in the in-band mode may be configured along with the LTE system in the corresponding frequency domain.

Therefore, in the cellular system supporting the LTE-lite terminal, there may be a need to identify whether the frequency band in which the corresponding LTE-lite terminals are operated is a frequency band in which the conventional LTE and LTE-A terminals exist or whether the frequency band in which the corresponding LTE-lite terminals are operated is an independent frequency band of the existing LTE and LTE-A systems. In other words, a need exists for a method for identifying whether the LTE-lite system is the in-band mode or the stand-alone mode. Also, in order to operate the normal LTE and LTE-A terminals and the LTE-lite terminal together in the same system, it is necessary to define the additional operation required for the LTE-lite terminal.

In the present disclosure, the frequency band in which the LTE and LTE-A terminals exist stands for a frequency band in which the actual LTE and LTE-A terminals can receive scheduling of control and data signals, and the frequency band independent of the LTE and LTE-systems stands for a frequency band in which the LTE and LTE-A terminals cannot receive scheduling of the control and data signals. For example, given an LTE frequency band set to be 20 MHz, only a region corresponding to 100 PRBs in the middle of a 20 MHz band is a frequency band in which the LTE and LTE-A terminals exist, and the rest regions may be defined as a frequency band independent of the LTE and LTE-A systems. On the other hand, the frequency band in which signals transmitted by the LTE and LTE-A systems do not exist or a frequency band received at a certain power or less may be called a frequency band independent of the LTE and LTE-A systems.

In order to solve the above-mentioned problem, the present disclosure is directed to the provision of a method and device for causing an LTE-lite terminal to distinguish between an in-band mode and a stand-alone mode and a method and device for operating an LTE-lite terminal so that the LTE-lite terminal is operated along with normal LTE and LTE-A terminals when being operated in an in-band mode.

Hereinafter, embodiments of the present disclosure will be described in detail with reference to the accompanying drawings. When it is decided that a detailed description for the known function or configuration related to the present disclosure may obscure the gist of the present disclosure, the detailed description therefor will be omitted. Further, the following terminologies are defined in consideration of the functions in the present disclosure and may be construed in different ways by the intention or practice of users and operators. Therefore, the definitions thereof should be construed based on the contents throughout the specification. Hereinafter, the base station is a subject performing resource allocation of a terminal and may be at least one of eNode B, Node B, a base station (BS), a wireless access unit, a base station controller, and a node on a network. The UE may include user equipment (UE), a mobile station (MS), a cellular phone, a smart phone, a computer, or a multimedia system performing a communication function. In the present disclosure, a downlink (DL) means a radio transmission path of a signal from a base station to a terminal and an uplink (UL) means a radio transmission path through which the terminal is transmitted to the base station. Further, the embodiment of the present disclosure describes the LTE or LTE-A system by way of example, but the embodiment of the present disclosure may be applied to other communication systems having similar technical background or a channel form. Further, the embodiment of the present disclosure may be applied to other communication systems by partially being changed without greatly departing from the scope of the present disclosure under the decision of those skilled in the art.

The narrow band terminal to be described below may be called the LTE-lite terminal. The LTE-lite terminal may include a terminal that is operated by transmitting and receiving only one PRB in the LTE and LTE-A systems, and may also include a terminal operated in a channel having a frequency bandwidth of 180 kHz or more independent of the LTE system.

The LTE-lite terminal to be described below may be operated together in the same system along with the normal LTE and LTE-A terminals. In the present disclosure, the LTE-lite terminal may be called the in-band mode. Meanwhile, the LTE-lite terminal may be operated in a bandwidth of 180 kHz or more independent of the LTE system. In this case, according to the present disclosure, the LTE-lite terminal may be called the stand-alone mode.

In the present disclosure, the frequency band in which the LTE and LTE-A terminals exist stands for a frequency band in which the actual LTE and LTE-A terminals can receive scheduling of control and data signals, and the frequency band independent of the LTE and LTE-systems stands for a frequency band in which the LTE and LTE-A terminals cannot receive scheduling of the control and data signals. For example, given an LTE frequency band set to be 20 MHz, only a region corresponding to 100 PRBs in the middle of a 20 MHz band is a frequency band in which the LTE and LTE-A terminals exist, and the rest regions may be defined as a frequency band independent of the LTE and LTE-A systems. On the other hand, the frequency band in which signals transmitted by the LTE and LTE-A systems do not exist or a frequency band received at a certain power or less may be called a frequency band independent of the LTE and LTE-A systems.

Further, in the present disclosure, the system operating the LTE-lite terminal is called the LTE-lite system. There may be the LTE-lite in the stand-alone mode operating the LTE-lite terminal regardless of the LTE-lite system and the LTE system in the in-band mode in which the LTE-lite terminal is operated in the frequency band in which the conventional LTE and LTE-A terminal exist. The LTE-lite system in the in-band mode can be configured along with the LTE system in the corresponding frequency domain and may be called an LTE base station (or system) or an LTE-lite base station (or system) that supports the LTE-lite terminal.

One aspect of the present disclosure is to provide a method in which an LTE-lite terminal transmits/receives only one PRB in the LTE system to access the LTE base station to be operated. More specifically, a method of transmitting an SSS signal in an in-band mode or in a stand-alone mode by another method, a method of identifying an in-band mode or a stand-alone mode by receiving and decoding an SSS signal, and a method for preventing an LTE-lite terminal from colliding with an existing LTE system is provided. The basic structure of the time-frequency domain of the LTE system will be described with reference to FIGS. 1, 3, 4A, 4B and 5.

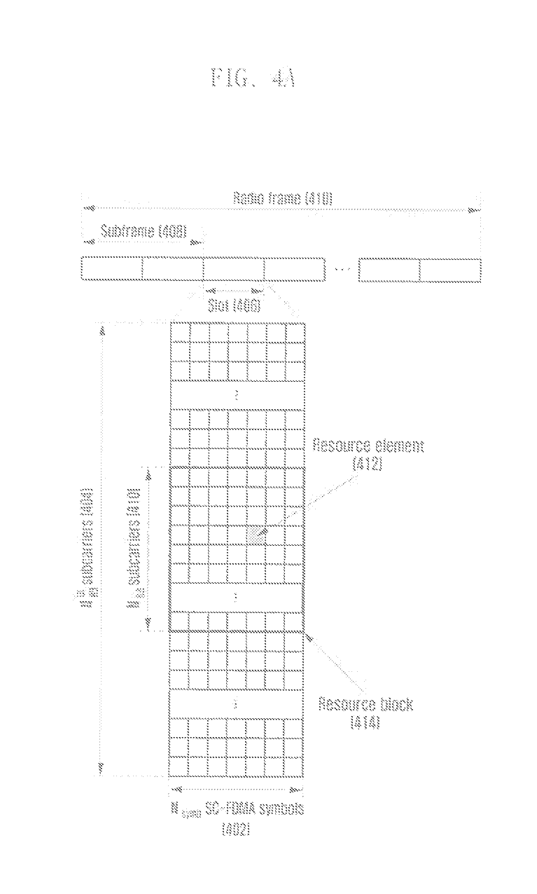

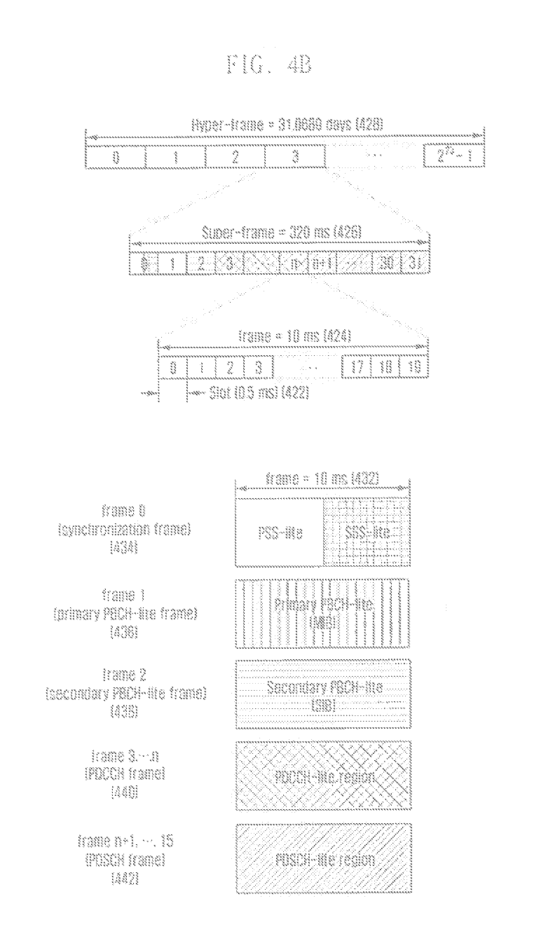

FIGS. 1 and 4A each are diagrams illustrating downlink and uplink frame structures in the LTE or LTE-A system. The downlink and the uplink are configured of sub frames 105 and 408 having a time length of 1 ms in common in the time domain or slots 106 and 406 having a time length of 0.5 ms. In the frequency domain, the downlink and the uplink are configured of NRBDL RBs 104 and NRBUL RBs 404. 10 subframes are gathered to form radio frames 114 and 410 having a time length of 10 ms and NRB subcarriers 110 and 410 configure resource blocks 108 and 414. In one slot, there are NsymbOFDM symbols 102 and SC-FDMA symbols 402 in the downlink and the uplink, respectively, and a part corresponding to one OFDM or SC-FDMA symbol and one subcarrier is called resource elements 112 and 412.

FIG. 4B is a diagram illustrating a frame structure that may be used in a downlink and an uplink of LTE-lite. The downlink and the uplink are configured of a slot 422 having a time length of 0.5 ms in common in a time domain, and 20 slots are gathered to form a frame 424 having a length of 10 ms. 32 frames configure a super-frame 426 having a length of 320 ms. 223-1 super-frames configure a hyper-frame 428. In the above description, the number of frames configuring one super-frame and the number of super-frames configuring one hyper-frame may be variously modified. In addition, the slot, the frame, the super-frame, and the hyper-frame may also be called different names.

One super-feme 426 may include a primary synchronization signal lite (PSS-lite) and a secondary synchronization signal lite (SSS-lite) 434 that are synchronization signals, primary PBCH-lite 436 and secondary PBCH-lite 438 that are physical broadcast channels, a PDCCH-lite 440 that is a control channel, and a PDSCH-lite 442 that is a data channel.

FIG. 4B illustrates an example in which the PSS-lite and the SSS-lite are transmitted in frame 0 of the super-frame, the primary PBCH-lite is transmitted in frame 1, the secondary PBCH-lite is transmitted in frame 2, and the control information and data information are transmitted in the rest fames. However, each physical signal and physical channels can be mapped to resources and transmitted by various methods. In addition, a separate reference signal may be transmitted by being included in the primary PBCH-lite (436). The secondary PBCH-lite, the PDCCH-lite, and the PDSCH-lite may include the CRS of the conventional LTE system or a separate reference signal. The PSS-lite, the SSS-lite, the primary PBCH-lite, and/or the secondary PBCH-lite in FIG. 4B may transmit information that the PSS, the SSS and/or the PBCH of the conventional LTE system shown in FIG. 3 transmit, and may adopt the structure of the PSS, the SSS and/or the PBCH of the LTE system.

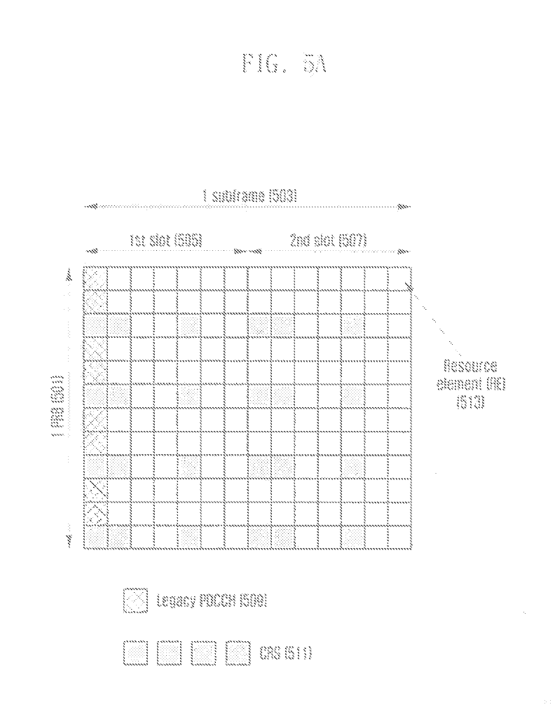

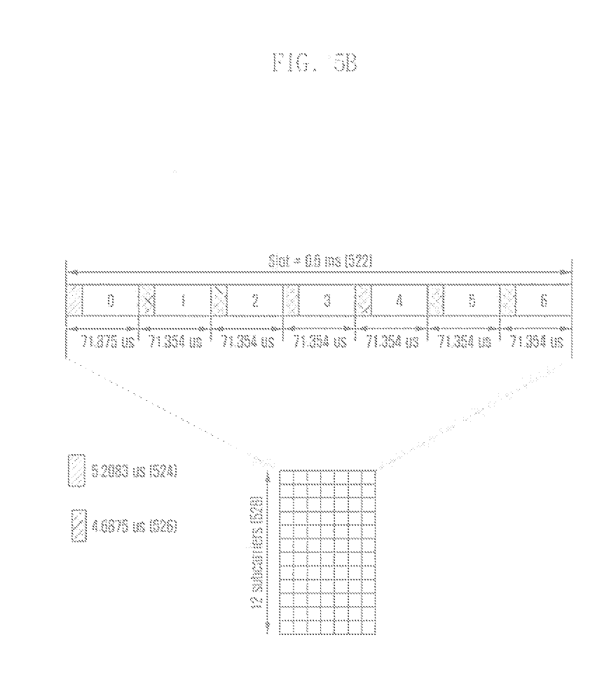

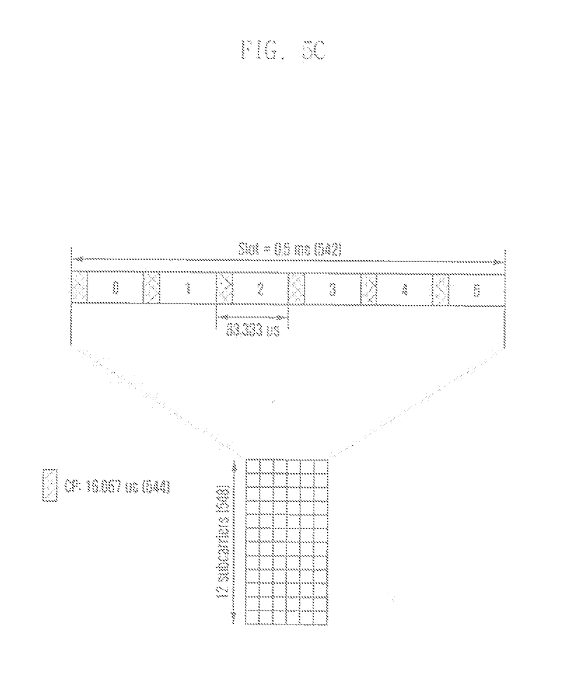

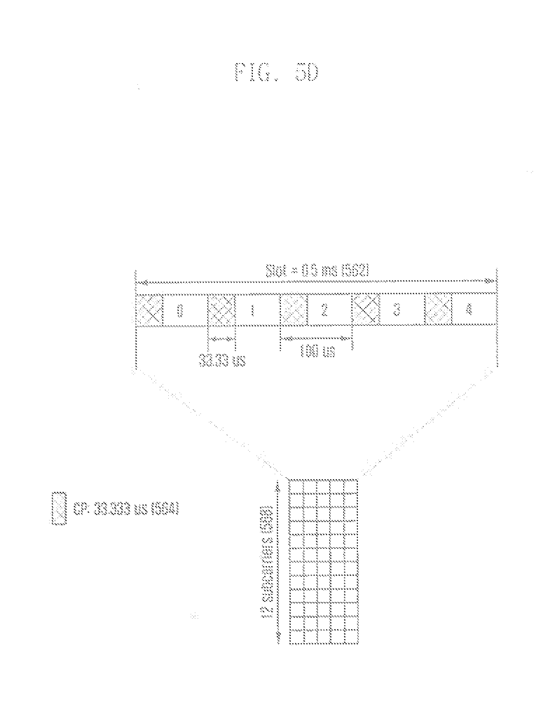

FIG. 5A is a diagram illustrating a 1 PRB pair 501 of the time-frequency domain which is the radio resource region in which the data or the control channel is transmitted on the downlink in the LTE system.

In FIG. 5A, an abscissa represents a time domain and an ordinate represents a frequency domain. The transmission time interval of the LTE system corresponds to 1 ms in one subframe 503. One subframe includes two slots 505 and 507, and each slot includes seven OFDM symbols in the LTE system in a normal CP mode. A PRB 501 in the frequency domain is a set of 12 continued subcarriers. In one OFDM symbol, a resource corresponding to one subcarrier is called a resource element (RE) 513, and a minimum unit in which the resource allocation is made in the LTE system.

24 REs are used as CRSs 511 in 1 PRB of one subframe. One subframe has a total of 14 OFDM symbols. Among those, 1, 2, or 3 OFDM symbols are allocated for PDCCH 509 transmission. FIG. 5 illustrates an example in which one OFDM symbol is used for PDCCH transmission. In other words, in the existing LTE system, up to three sub frames at a head part of one subframe are used for physical downlink control channel transmission.

In the present disclosure, the operation required in the in-band mode of the LTE-lite in which the LTE-lite terminal is operated in the same system along with the conventional LTE and LTE-A terminals will be described. Hereinafter, the operation in the in-band mode to be described below may be identically operated in the stand-alone mode operated in a bandwidth of 180 kHz or more independent of the LTE system.

FIG. 5B is a diagram illustrating a slot structure of the LTE-lite together with an OFDM symbol and a CP length, when 1 PRB 528 is used in an LTE-lite system in a normal CP mode of the conventional LTE system. In the present disclosure, the slot structure of FIG. 5B is called a normal CP structure. One slot 522 includes a total of 7 OFDM symbols, and a length of each OFDM symbol is 66.667 μs. Samples of a cyclic prefix (CP) are added to head parts of each OFDM symbol. A CP length of the first OFDM symbol is 5.2083 μs 524, and a CP length of the rest OFDM symbols is 4.6875 μs 526.

FIG. 5C is a diagram illustrating the slot structure of the LTE-lite along with the OFDM symbol and the CP length, when 1 PRB (548) is used in the LTE-lite system in an extended CP mode of the conventional LTE system. In the present disclosure, the slot structure of FIG. 5C is called an extended CP structure. One slot 542 includes a total of 6 OFDM symbols, and a length of each OFDM symbol is about 66.667 μs. A CP is added to head parts of each OFDM symbol, in which a CP length is about 16.667 μs 544.

FIG. 5D is a diagram illustrating the slot structure of the LTE-lite system using 1 PRB 568 along with the OFDM symbol and the CP length. In the present disclosure, the slot structure of FIG. 5D is called a longer-extended CP structure. One slot 562 includes a total of 5 OFDM symbols, and a length of each OFDM symbol is about 66.667 μs. A CP is added to head parts of each OFDM symbol, in which a CP length is about 33.333 μs 564.

The LTE-lite may be operated using one of the normal CP structure of FIG. 5B and the extended CP structure of FIG. 5C, when being operated in the in-band mode operation. In addition, the LTE-lite may be operated using one of the normal CP structure of FIG. 5B, the extended CP structure of FIG. 5C, and the longer-extended CP structure of FIG. 5D, when being operated in the stand-alone mode.

In addition, when LTE-lite terminal accesses the LTE-lite system in the in-band mode or the stand-alone mode, a process of notifying which of the in-band mode and the stand-alone mode the accessed LTE-lite system corresponds to may be required. Meanwhile, if the LTE-lite is operated in an in-band mode operated in the frequency band of the LTE system, an operation for coexistence with the conventional LTE and LTE-A terminals is required. Hereinafter, a method of indicating one of the above modes using the PSS and the SSS and an operation of the LTE-lite for coexistence with the conventional LTE terminal in the in-band mode will be described. The present disclosure can be applied without any limitation in the range where the number of RBs used for transmission and reception in the conventional LTE and LTE-A systems is greater than or equal to 6 and smaller than 110. It should be noted that the above description is only an embodiment of the present disclosure and is not necessarily limited to such operation. In addition, the following embodiments can be also interchangeably used.

### First Embodiment

The first embodiment will describe a method for transmitting different SSSs in the in-band mode and the stand-alone mode of the LTE-lite system.

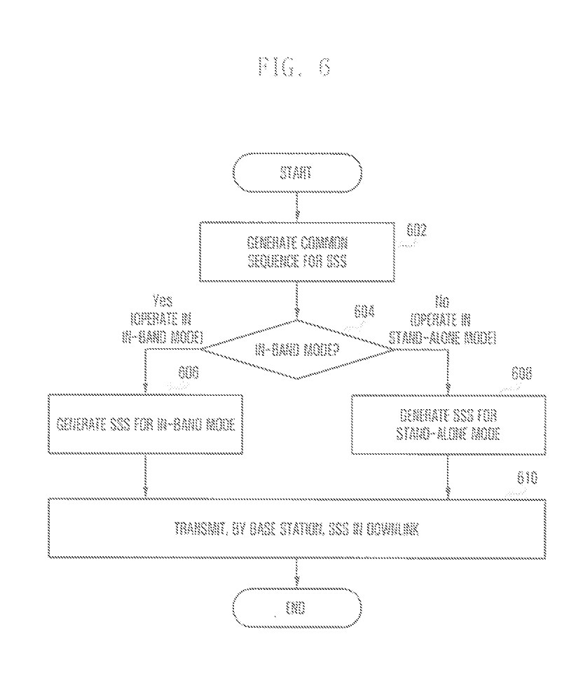

FIG. 6 is a diagram illustrating a process in which an LTE-lite base station generates a sequence to transmit a synchronization signal to an LTE-lite terminal and transmits an SSS.

The PSS and the SSS for the LTE-lite terminal should be transmitted within 1 PRB only. The LTE-lite terminal performs the decoding of the PSS prior to decoding the SSS, and attempts to decode the SSS after decoding the PSS. The PSS for LTE-lite may be configured of two or more sequences. If the LTE-lite base station generates and transmits the SSS, the LTE-lite base station may use another SSS according to the in-band mode and the stand-alone mode. If the SSS decoding succeeds during the synchronization the LTE-lite terminal with the LTE-lite base station later using the same, the LTE-lite terminal may automatically identify whether the LTE-lite system is in the in-band mode or the stand-alone mode.

As an example, a case where SSS d (n) is generated using the common sequence c (n) in FIG. 6 will be described. The sequence c (n) may be given as an m sequence, a PN sequence, a Zadoff-Chu sequence or the like 602, in which n may be given as an integer from 0 to NSSS-1. The NSSS may be 12 as a length of the SSS. The SSS d (n) may be defined by the following Equations (1), (2) and (3).

$$\begin{matrix}d ( n ) = \{ \begin{matrix} c ( n ) & for in \text{-} band mode \\ - c ( n ) & for stand \text{-} alone mode\end{matrix} & [ Equation 1 ] \\ d ( n ) = \{ \begin{matrix}{s}_{0} ( n ) c ( n ) & for in \text{-} band mode \\ {s}_{1} ( n ) c ( n ) & for stand \text{-} alone mode\end{matrix} & [ Equation 2 ] \\ d ( n ) = \{ \begin{matrix}( {s}_{0} ( n ) + c ( n ) ) mod 2 & for in \text{-} band mode \\ ( {s}_{1} ( n ) + c ( n ) ) mod 2 & for stand \text{-} alone mode\end{matrix} & [ Equation 3 ]\end{matrix}$$

That is, the LTE-lite base station determines whether the LTE-lite system is operated in the in-band mode or the stand-alone mode in the corresponding frequency band (S604). As the determination result, if the LTE-lite system is operated in the in-band mode, the SSS d (n) is generated as an SSS for the in-band mode (S606) and if the LTE-lite system is operated in the stand-alone mode, the SSS d(n) is generated as an SSS for the stand-alone mode (S610). The method for generating an SSS according to the in-band mode or the stand-alone mode is determined in advance and thus may be promised beforehand between the base station and the terminal. The generated d (n) is transmitted using resources in which the LTE-lite base station transmits the SSS in the downlink.

In the above Equation 2, the sequence s0 (n) and s1 (n) may be defined by various methods. For example, it may be defined by the following Equation 4.

s₀(n)=\tilde{s}((n)mod31)

s₁(n)=\tilde{s}((n+16)mod31) [Equation 4]

In the above Equation 4, [symbol] is defined as [symbol] , and x (i) is defined as [symbol] in 0≤i≤25. In the above description, X(0)=0, x (1)=1, x (2)=0, x (3)=0, and x (4)=1. It is also possible that another natural number value is used instead of 16 in the above Equation 4.

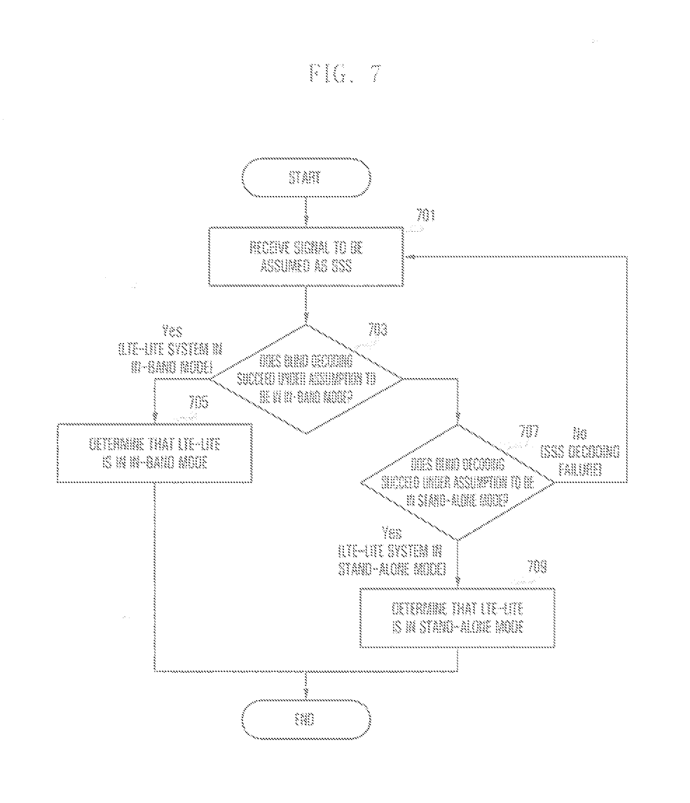

FIG. 7 is a diagram illustrating an operation of identifying whether the LTE-lite system is in an in-band mode or a stand-alone mode in a process of receiving and decoding an SSS by the LTE-lite terminal. The method for generating and transmitting an SSS differently according to the above-described in-band mode or stand-alone mode is merely an example and is not necessarily limited to the illustrated embodiment. Therefore, it will be possible to generate and transmit an SSS differently according to the in-band mode or the stand-alone mode as a similar modification.

The LTE-lite terminal receives an SSS signal when the SSS is received (S701), and first performs blind decoding (S703) under the assumption that it is the SSS transmitted from the LTE-lite system operated in the in-band mode. The blind decoding may mean performing the decoding without knowing exactly what the transmitted signal is. If the SSS decoding succeeds after the LTE-lite system is assumed to be in the in-band mode, the LTE-lite terminal determines that the LTE-lite system operated in the corresponding frequency domain is the in-band mode (S705). If the SSS decoding fails after the LTE-lite system is assumed to be the in-band mode, the LTE-lite terminal performs SSS blind decoding (S707) under the assumption that the LTE-lite system is in the stand-alone mode. If the SSS decoding succeeds after the LTE-lite system is assumed to be in the in-band mode, the LTE-lite terminal determines that the LTE-lite system operated in the corresponding frequency domain is in the in-band mode (S709).

If the SSS decoding fails after the LTE-lite system is in the stand-alone mode, the LTE-lite terminal receives the SSS (S701) and again performs the blind decoding on the received SSS. During the process of decoding the SSS blind described above, the in-band mode is assumed and the blind decoding is first performed, and the stand-alone mode is assumed and the blind decoding is performed at the time of the failure. However, it may be easily modified to assume the stand-alone mode by changing the order in which the mode is assumed at the time of the decoding and first perform the blind decoding, and assume the in-band mode and perform the blind decoding at the time of the failure.

The SSS in the above embodiment is different from the SSS in the conventional LTE and LTE-A systems, and may be one of the synchronization signals for the LTE-lite. For convenience, it is called the SSS, but may be called PSS, PSS1, PSS2, SSS1, SSS2, SSS or the like.

### Second Embodiment

The second embodiment describes a method in which the LTE-lite system operated in an in-band mode transmits the information on the conventional LTE system to the LTE-lite terminal.

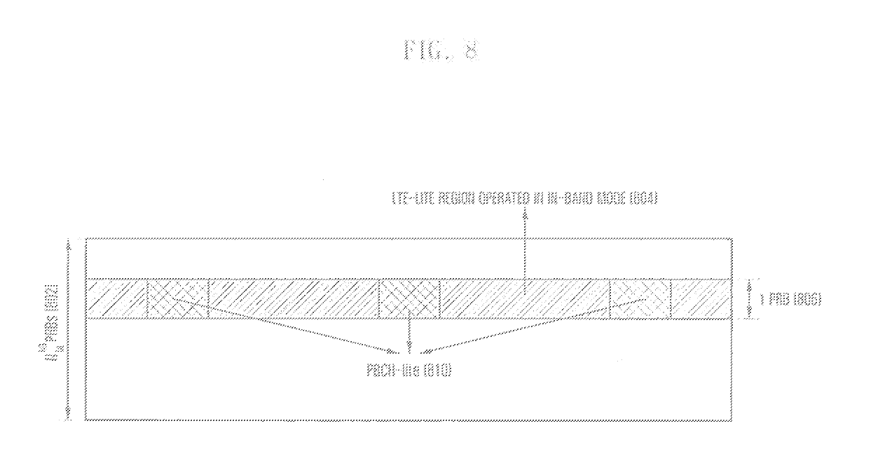

FIG. 8 is a diagram illustrating a frequency-time resource in which the LTE-lite system is operated in the in-band mode at 1 PRB in a frequency band in which the conventional LTE and LTE-A systems exist. The LTE and LTE-A systems may be given an integer number in which a total number of RBs is 6 or more (S802). One PRB 806 of the plurality of PRBs may be operated for the purpose of the LTE-lite (S804). The LTE-lite terminal may not receive the PBCH of the conventional LTE and LTE-A systems, and the LTE-lite base station separately transmits the PBCH (hereinafter, PBCH-lite 810) for the LTE-lite terminal to transmit the necessary information to the LTE-lite terminals. The PBCH-lite is allocated to 12 subcarriers in the frequency domain in the LTE and LTE-A systems, and the method for mapping time and resources to be transmitted and the transmission period may be predetermined in advance by the LTE-lite system. The frequency-time resource allocation method of the PBCH-lite illustrated in FIG. 8 is one example, and the mapping may be made within 1 PRB by various methods. In the present disclosure, the PBCH-lite can be interchangeably used with narrow band PBCH (NB-PBCH or NPBCH) and the like.

The LTE-lite base station may include information on a PRB number of the conventional LTE and LTE-A systems in which a corresponding frequency band exists in a master information block (MIB) transmitted on the PBCH-lite. In other words, it means that the PBCH-lite may include information about where 1 PRB transmitted by the PBCH-lite is located within the conventional LTE and LTE-A system bandwidths. That is, in FIG. 8, information notifying whether PRB 806 in which the LTE-lite is located corresponds to what PRE of all the PRBs 802 should be included in the PBCH-lite. The MIB may be called a narrow band MIB (NB-MIB).

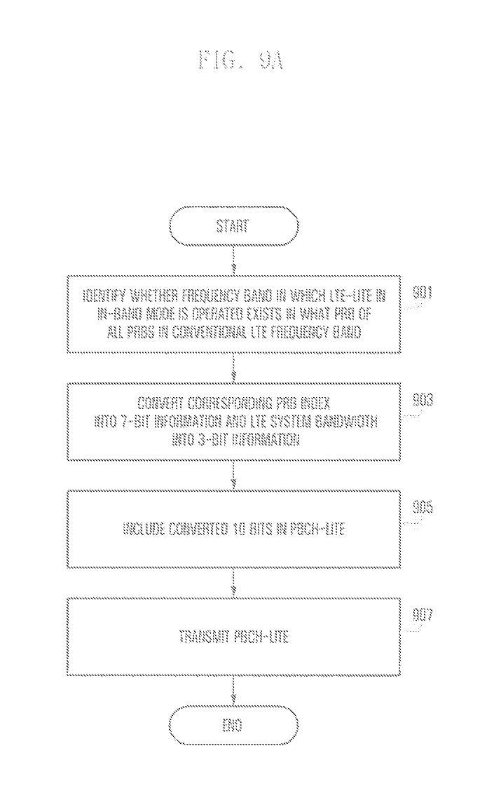

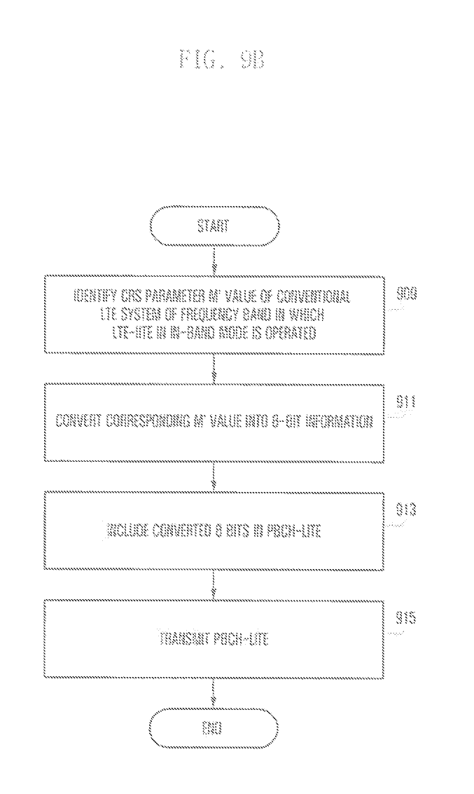

FIG. 9A is a diagram illustrating a process in which the LTE-lite base station transmits information on which PRB is operated in the conventional LTE system by including the information in a PBCH-lite.

Referring to FIG. 9A, the LTE-lite base station identifies whether the frequency band for the LTE-lite operated in the in-band mode corresponds to what PRB of all the PRBs in the entire frequency domain of the conventional LTE and LTE-A systems (S901). The LTE-lite base station converts the PRB index and the system bandwidth, which are the identified information, into bit information (S903). The bit information conversion may be made by various methods. A method for displaying, by a binary number, what PRB of all the PRBs is located from PRB index 0 in the conventional LTE and LTE-A systems, a method for displaying, by a binary number, what PRB of all the PRBs is located from a last PRB index, a method for displaying, by a binary number, what PRB of all the PRBs is located except 6 PRBs in which the PSS, the SSS, and the PBCH are transmitted in the conventional LTE and LTE-A systems, or the like may be used. In addition, after the region that may not be used for the purpose of the LTE-lite among the PRBs of the conventional LTE and LTE-A is established in advance, the PRB index may be calculated only in the rest regions and represented by a binary number. Alternatively, the PRB index used in the frequency band of the conventional LTE and LTE-A may be used as it is. For example, the maximum number of PRBs used by the conventional LTE system is 110. Therefore, in order to indicate all the PRB regions, the PRB index information may be converted into 7 bits. For example, bit information 0000100 of the PRB index may mean PRB index No. 4. The number of bits of the PRB location information in the LTE-lite frequency band operated in the in-band mode may be fixed to 7 bits at all times, or if is possible to reduce the number of bits or represent a location by the number of bits larger than 7 bits by changing a method for representing a location. For example, the PRB location information may be represented by 4 bits, 5 bits, 6 bits. The PRB index may use any method that can determine which LTE-lite is operated in which PRB in the conventional LTE and LTE-A frequency domains. In this manner, the LTE-lite base station may include the PRB index converted into 7-bit information in a binary number and the system bandwidth information of the conventional LTE system converted into 3 bits in the PBCH-lite (S905), and subject to CRC addition and channel coding, and transmit the information to PBCH-lite (S907). The LTE-lite terminal may identify the PRB index of the conventional LTE system using the above information, and grasp the CRS of the conventional LTE system using the same.

In the above description, the information to be included in the PBCH-lite is described in the case of the in-band mode. However, in the case of the stand-alone mode, the 7-bit information indicating the PRB index described above may be omitted, and 7 bits representing any value may be included. In addition, 3 bits converting the conventional LTE system bandwidth may be represented by 2 bits.

In the above description, the PRB index and the LTE system bandwidth information are included in the PBCH-lite, but the CRS-related information existing in the conventional LTE system may be included in the PBCH-lite, instead of the two information. FIG. 9B is a diagram illustrating a method of transmitting CRS-related information of the conventional LTE system by including the CRS-related information in the PBCH-lite. The conventional CRS is generated depending on the following Equation 5 below and mapped to a resource element.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , m = 0 , 1 , … , 2 {N}_{RB}^{max , DL} - 1 \qquad [ Equation 5 ]$$

In the above Equation 5, ns represents a slot number in a frame, and 1 represents an OFDM symbol number within one slot. c (i) is a pseudo-random sequence used in the conventional LTE, and an initial value is defined as [symbol] and Ncp=1 (for normal CP) or 0 (for extended CP). The NIDcell is a cell ID number.

The CRS sequence determined depending on the above Equation 5 is mapped to a resource in the same manner as the following Equation 6.

a_{k,l}^{(p)}=r_{l, n}_{ₛ}(m′) [Equation 6]

In the above Equation 6, the CRS value mapped to a k-th subcarrier and the corresponding slot i-th resource element is determined as r_{l,n}_{ₛ}(m′). K and I values to which the CRS is mapped are determined by the following Equations 7, 8, and 9.

$$\begin{matrix}k = 6 m + ( v + {v}_{shift} ) mod 6 \\ l = \{ \begin{matrix}0 , {N}_{symb}^{DL} - 3 & if p ∈ \{ 0 , 1 \} \\ 1 & if p ∈ \{ 2 , 3 \}\end{matrix} \\ m = 0 , 1 , … , 2 \cdot {N}_{RB}^{DL} - 1 & [ Equation 7 ] \\ {m}^{′} = m + {N}_{RB}^{max , DL} - {N}_{RB}^{DL} & [ Equation 8 ] \\ v = \{ \begin{matrix}0 & if p = 0 and l = 0 \\ 3 & if p = 0 and l \neq 0 \\ 3 & if p = 1 and l = 0 \\ 0 & if p = 1 and l \neq 0 \\ 3 ( {n}_{s} mod 2 ) & if p = 2 \\ 3 + 3 ( {n}_{s} mod 2 ) & if p = 3 \end{matrix} & [ Equation 9 ]\end{matrix}$$

The vshift is determined as v_{shift}=N_{ID}^{cell} mod6.

Among the equations for generating and mapping the CRS, a m′ value obtained based on the above Equation 8 may range from 0 to 219, so the m′ may be represented by 8 bits in a binary number. The LTE-lite base station may identify the m′ value (S909), convert the corresponding value into 8-bit information (S911), and then include 8 bits in the PBCH-lite (S913). The LTE-lite transmits the information including the 8-bit information indicating the m′ to the PBCH-lite (S915). The above method is merely an example, and a value indicating the information of at least one of m, m′ and NRBDL is converted into 4 bits, 5 bits, 6 bits, or 7 bits based on a separate rule, and can be transmitted in the PBCH-lite.

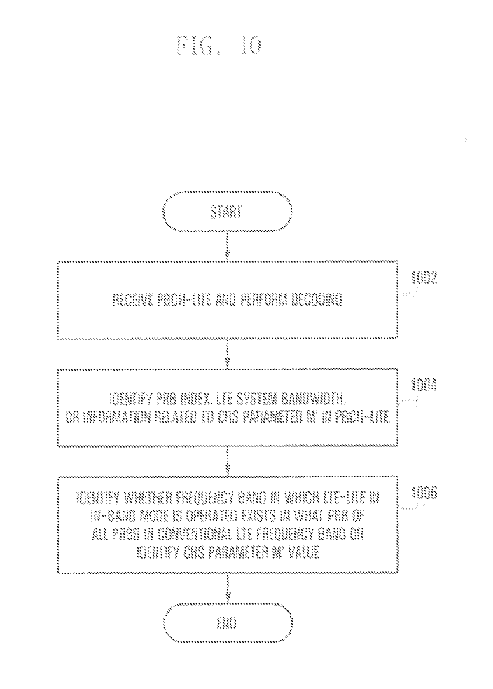

FIG. 10 is a diagram illustrating a process in which the LTE-lite system identifies information on how many PRBs the corresponding frequency domain is located at in conventional LTE system when being operated in the in-band mode or the LTE-lite terminal identifies the CRS-related information of the conventional LTE system from the PBCH-lite. The terminal receives the signal on the PBCH-lite in the previously promised frequency-time resource region and performs the decoding of the received signal (S1002). The LTE-lite terminal identifies the bit information indicating the PRB index and/or the LTE system bandwidth in the successfully decoded signal or the bit information indicating a CRS parameter m′ value corresponding to the above Equation 8 (S1004). Based on the information, the LTE-lite terminal identifies whether the LTE-lite system is operated in the PRB at which location of the conventional LTE system frequency band or the CRS parameter m′ value of the conventional LTE system (S1006). In step 1004, the above method is merely an example. In addition to identifying the bit information indicating the m′ value, a method of identifying bit information indicating at least one of m, m′, and NRBDL may be used.

The information included in the PBCH-lite described above may be transmitted on another physical channel, and may be transmitted from the LTE-lite base station to the LTE-lite terminal. That is, even if the name of the physical channel is not the PBCH-lite, the above-mentioned method may be easily applied.

### Third Embodiment

The third embodiment describes a method for reusing the CRS existing in the conventional LTE system when the LTE-lite terminal is operated m the in-band mode within the conventional LTE system bandwidth.

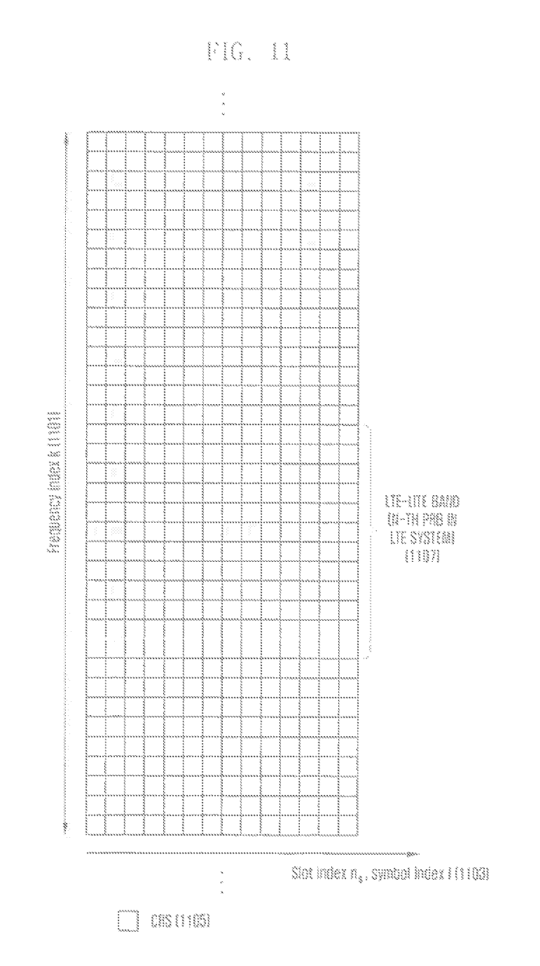

FIG. 11 is a diagram illustrating a resource in a conventional LTE system bandwidth. In a frequency domain 1101, it is assumed that there are a total of NRBDL RBs. Among those, the LTE-lite system uses an N-th RB 1107. A CRS 1105 is located in some of the resource elements, and every slot structure is repeated on a time base 1103.

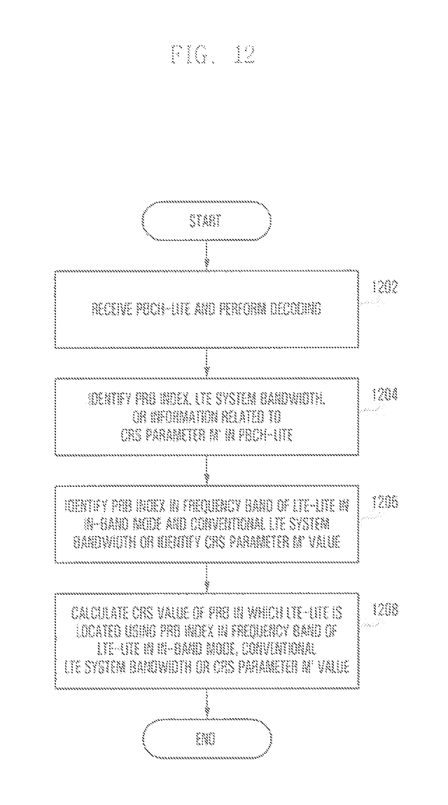

FIG. 12 is a diagram illustrating a process of identifying a CRS value on a PRB where the LTE-lite system is located using the information included in the PBCH-lite after PBCH-lite decoding when Lie LTE-lite system is operated in the in-band mode. The terminal receives the signal on the PBCH-lite and performs the decoding of the signal (S1202). The LTE-lite terminal identifies the bit information indicating the PRB index and/or the LTE system bandwidth in the successfully decoded signal or the bit information indicating a CRS parameter m′ value corresponding to the above Equation 8 (S1204). Based on the information, the LTE-lite terminal identities whether the LTE-lite system is operated in the PRB at which location of the conventional LTE system frequency band or the CRS parameter m′ value of the conventional LTE system (S1206). If the LTE system bandwidth and the information related to the PRB index are included in the signal, the LTE-lite terminal calculates the CRS value located in the PRB, in which the corresponding LTE-lite system is operated, based on the above Equations 6, 7, 8, and 9 (S1208). Alternatively, when the CRS parameter m′ value is included in the signal, similarly, the CRS value located in the PRB in which the corresponding LTE-lite is operated is calculated based on the above Equations 6, 7, 8, and 9 (S1208). That is, the LTE-lite system may use the CRS generated in the same method as the conventional LTE system, and the LTE-lite terminal may estimate the channel status or demodulate the data using the calculated CRS value.

The information included the signal on the PBCH-lite described above may be transmitted on another physical channel, and may be transmitted from the LTE-lite base station to the LTE-lite terminal. That is, even if the name of the physical channel is not the PBCH-lite, the above-mentioned method may be easily applied.

### Fourth Embodiment

The fourth embodiment describes the method in which the LTE-lite system is operated in two or more PRBs within the bandwidth of the conventional LTE system.

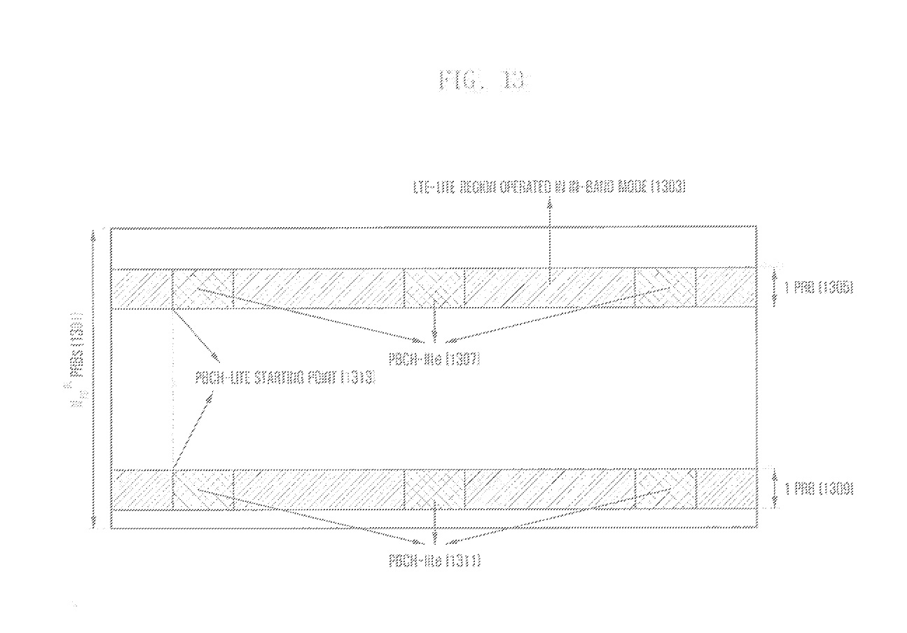

FIG. 13 is a diagram illustrating a method for operating the LTE-lite system at two or more PRBs within the conventional LTE system bandwidth. In FIG. 13, there is the conventional LTE system band having a total of NRBDL RBs 1301. In the LTE system band 1301, there exist two LTE-lite systems 1303 operated in the in-band mode, and each LTE-lite system uses 1 PRB 1305 and 1309. Signals on PBCH-lites 1307 and 1311 are transmitted in each PRB. At this time, two LTE-lite systems transmitted in two PRBs transmit a signal on the PBCH-lite at the same timing, such that the PBCH-lite start timing 1313 may be the same. In other words, the LTE-lite system may be operated independently in two PRBs, but is a method operated by intentionally adjust starting points 1313 of the PBCH-lites transmitted from both LTE-lite systems to be the same.

Although the two LTE-lite systems are considered in this embodiment, it is possible to extend to the same method even when two or more LTE-lite systems exist.

### Fifth Embodiment

The fifth embodiment describes the method in which the LTE-lite system is operated in two or more PRBs within the conventional LTE system bandwidth.

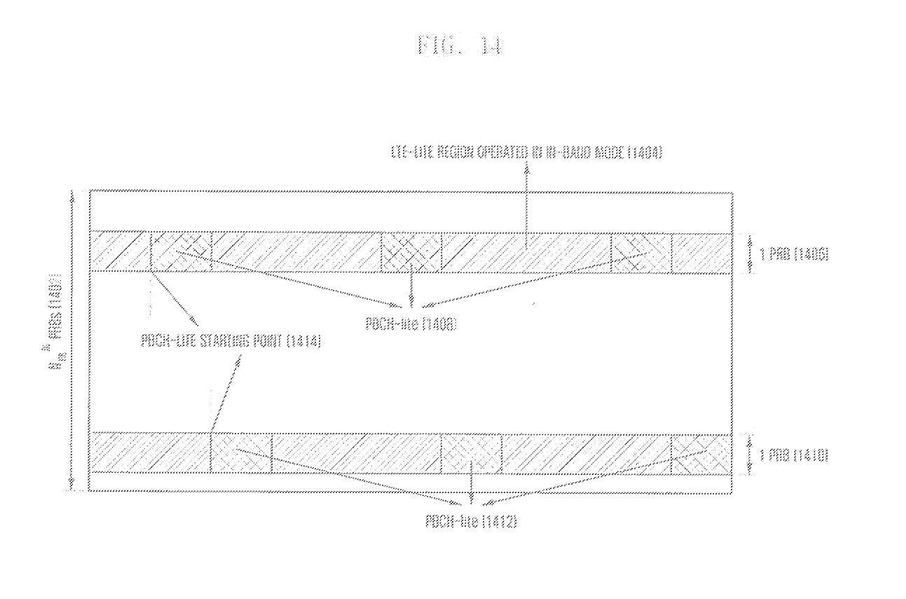

FIG. 14 is a diagram illustrating a method for operating the LTE-lite system at two or more PRBs within the bandwidth of the conventional LTE system. Referring to FIG. 14, there is an LTE system band having a total of NRBDL RBs 1402. In the LTE system band 1402, there exist two LTE-lite systems 1404 operated in the in-band mode, and each LTE-lite system uses 1 PRB 1406 and 1410. The signals on the PBCH-lites 1408 and 1412 are transmitted to each PRB. Since two LTE-lite systems on two PRBs transmit the signals on the PBCH-lites at different timings, such that PBCH-lite starting points 1414 of each LTE-lite system are not the same. In other words, the LTE-lite system may be operated independently in two PRBs, but is a method operated by intentionally adjust starting points 1414 of the PBCH-lites transmitted from two LTE-lite systems to be the same.

In addition, the difference between the starting points of the PBCH-lites transmitted in the two LTE-lite systems may be set to be an integer multiple of 10 ms (i.e., the slot number in which the PBCH-lite is transmitted is the same) and operated.

Although the two LTE-lite systems are considered in this embodiment, it is possible to extend to the same method even when two or more LTE-lite systems exist.

### Sixth Embodiment

The sixth embodiment describes a method in which the LTE-lite system does not use a part or all of a specific slot periodically when the LTE-lite system is operated in the in-band mode or the stand-alone mode.

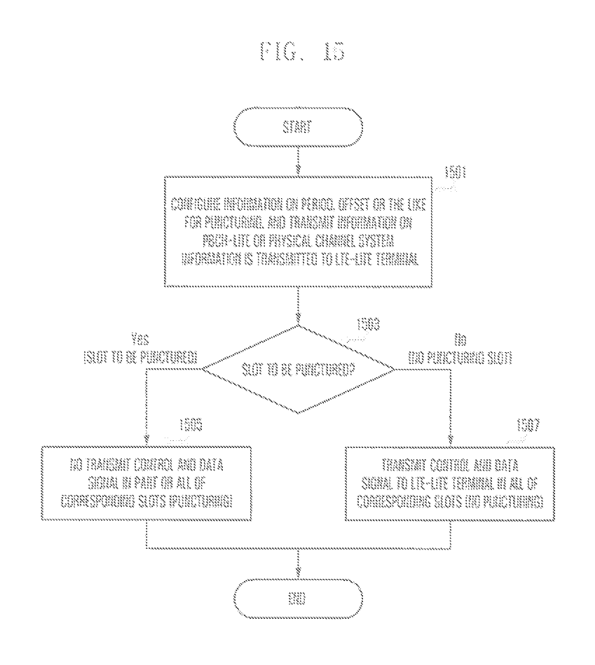

FIG. 15 is a diagram illustrating a puncturing process in which the LTE-lite base station does not periodically transmit control and data signals in a specific slot when transmitting the control and data signals to the LTE-lite terminal. Referring to FIG. 15, first of all, the LTE-lite base station transmits information related to a slot in which the control and data signals are not transmitted to the LTE-lite terminal on the PBCH-lite or another physical channel for transmitting system information (S1501). The information related to the slots in which the control and data signals are not to be transmitted (which may be represented as being punctured) may include information on a period of the slots to be punctured, offset information, and a symbol to be punctured. The LTE-lite base station determines whether a slot transmitting a signal is the slot to be punctured while transmitting the signal to the LTE-lite terminal (S1503). If the corresponding slot is the slot to be punctured, the LTE-lite base station does not transmit the control and data signals in a part or all of the corresponding slots (S1505). The resource to be punctured in the corresponding slot may be known using information related to an OFDM symbol number or a resource element number included in a signal on the PBCH-lite or another physical channel, or it may be promised in advance that transmission is not performed in the entire slot. On the other hand, after the LTE-lite base station determines that the slot is the slot to be punctured (S1503), if the corresponding slot is the slot which is not be punctured, the LTE-lite base station transmits the control and data signals are transmitted to the LTE-lite terminal in all the corresponding slots (S1507). The corresponding slot may include a reference signal.

The information related to the slot to be punctured which is known in advance on the PBCH-lite or the physical channel on which the system information is transmitted may include the following information.
Period of slot to be punctured: it may be promised in advance to be set to be 5 ms, 10 ms, 20 ms, 40 ms, 80 ms, 160 ms, 320 ms, 640 ms, 1280 ms or the like. This information may be indicated using bit information.
Offset of slot to be punctured: It may be set that the slot corresponding to the offset applied along with the period is punctured. The period and the offset information may be indicated together as a single index or bit information.

The information on the puncturing can be represented in various ways. For example. If the period of the slot to be punctured may be 5 ms, 10 ms, and 20 ms, the puncturing period is represented by 2 bits. 00 may indicate no puncturing slot, 01 may indicate puncturing of one slot every period of 5 ms, 10 may indicate puncturing of one slot every period of 10 ms, and 11 may indicate puncturing of one slot every period of 20 ms. In order to additionally indicate the offset value, when the period of the puncturing slot is 20 ms, a total of 40 slots are located at 20 ms, such that a bitmap using 40 bits may be used to notify from which slot the puncturing is to be performed. The above-described method is merely an example, and can be easily applied by various methods.

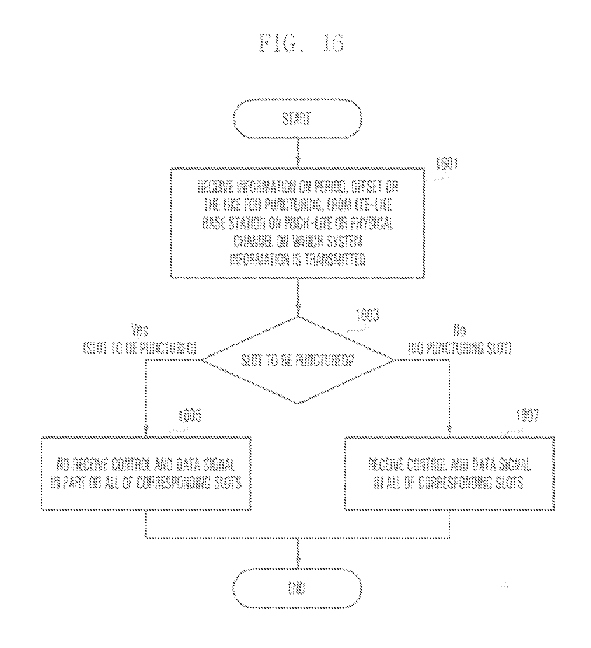

FIG. 16 is a diagram illustrating a process in which the LTE-lite terminal does not periodically receive the control and data signals in a predetermined specific slot (i.e., a punctured slot) when receiving a signal from the LTE-lite base station. Referring to FIG. 16, first of all, the LTE-lite terminal receives information related to a slot in which the control and data signals are not transmitted from the LTE-lite base station on the PBCH-lite or another physical channel for transmitting system information (S1602). The information on the slot in which the control and data signals are not to be transmitted may include information on a period of a slot to be punctured, offset information, and a symbol to be punctured. The LTE-lite terminal determines whether a slot to receive a signal is the slot to be punctured (S1604). If the corresponding slot is the slot to be punctured, the LTE-lite terminal does not receive the control and data signals in a part or all of the corresponding slots (S1604). The part to be punctured in the corresponding slot may be known using information related to an OFDM symbol number or a resource element number included in a signal on the PBCH-lite or another physical channel, or it may be promised in advance that transmission is not performed in the entire slot. On the other hand, if it is determined that the corresponding slot is the slot not to be punctured, the LTE-lite terminal receives the control and data signals from the LTE-lite base station in the entire slot (S1606).

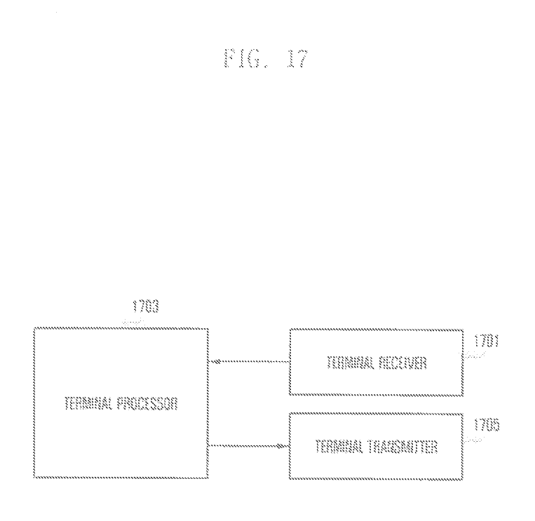

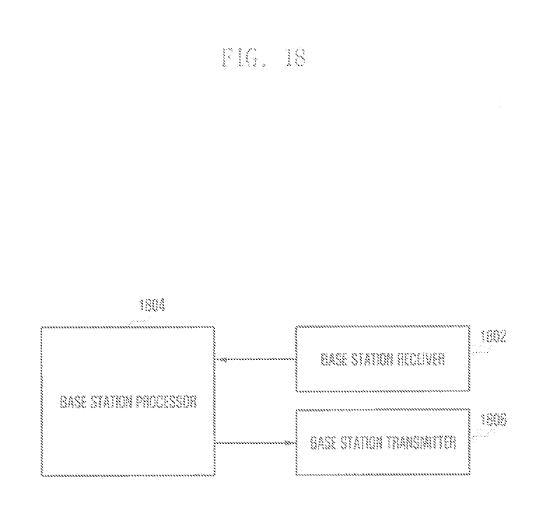

FIGS. 17 and 18 are block diagrams illustrating a structure of a terminal and a base station which may perform the above embodiments of the present disclosure. A transmitter, a receiver, and a processor of the terminal and the base station are each illustrated in FIGS. 1 and 18. The operation of the base station and the terminal for transmitting/receiving a signal in the in-band mode and the stand-alone mode of the LTE-lite are described in the first to sixth embodiments. In order to perform this, the receiver unit, the processor, and the transmitter of the base station and the terminal of FIGS. 17 and 18 should be operated according to each embodiment. The base station and the terminal of FIGS. 17 and 18 can be understood as an LTE-lite base station and an LTE-lite terminal.

FIG. 17 is a block diagram illustrating an internal structure of a terminal according to an embodiment of the present disclosure. As illustrated in FIG. 17, the terminal according to the embodiment of the present disclosure may include a terminal receiver 1701, a terminal transmitter 1705, and a terminal processor 1703.

The terminal receiver 1701 and the terminal transmitter 1705 are collectively referred to as a transceiver. The transceiver may transmit/receive a signal to/from the base station. The signal may include control information and data.

To this end, the transceiver may include an RF transmitter that up-converts and amplifies a frequency of the transmitted signal, an RF receiver that low-noise-amplifies the received signal and down-converts the frequency, or the like. Further, the transceiver may receive a signal through a radio channel and output the received signal to the terminal processor 1703 and transmit the signal output from the terminal processor 1703 through the radio channel.

The terminal processor 1703 may control a series process to operate the terminal according to the embodiment of the present disclosure as described above.

FIG. 18 is a block diagram illustrating an internal structure of a base station according to the embodiment of the present disclosure. As illustrated in FIG. 18, the base station of the present disclosure may include a base station receiver 1802, a base station transmitter 1806, and a base station processor 1804.

The base station receiver 1802 and the base station transmitter 1806 are collectively referred to as a transceiver. The transceiver may transmit/receive a signal to/from the terminal The signal may include control information, data, physical broadcast channel, and a reference signal.

To this end, the transceiver may include an RF transmitter that up-converts and amplifies a frequency of the transmitted signal, an RF receiver that low-noise-amplifies the received signal and down-converts the frequency, or the like. Further, the transceiver may receive a signal through a radio channel and output the received signal to the base station processor 1804 and transmit the signal output from the base station processor 1804 through the radio channel.

The base station processor 1804 may control a series process to operate the base station according to the embodiment of the present disclosure as described above.

The embodiments of the present disclosure disclosed in the present specification and the accompanying drawings have been provided only as specific examples in order to assist in understanding the present disclosure and do not limit the scope of the present disclosure. That is, it is obvious to those skilled in the art to which the present disclosure pertains that other change examples based on the technical idea of the present disclosure may be made without departing from the scope of the present disclosure. Further, each embodiment may be combined and operated as needed. For example, the first embodiment and the second embodiment of the present disclosure are combined with each other to operate the base station and the terminal.

1. A method for transmitting, by a base station, a control signal to a terminal, comprising:
identifying, by the base station, a PRB index of a physical resource block (PRB) in which a narrow band LTE system is located; and
transmitting information related to the PRB index to the terminal,
wherein the PRB index is a PRB index of an LTE system.

2. The method of claim 1, wherein the information related to the PRB index is 5 bits.

3. The method of claim 1, wherein the narrow band LTE system is an in-band system.

4. The method of claim 1, wherein the information related to the PRB index is transmitted on a physical broadcast channel.

5. A method for receiving, by a terminal, a control signal from a base station, comprising:
receiving information related to a PRB index of a physical resource block (PRB) in which a narrow band LTE system is located; and
identifying the PRB index based on the information related to the PRB index,
wherein the PRB index is a PRB index of an LTE system.

6. The method of claim 5, wherein the information related to the PRB index is 5 bits.

7. The method of claim 5, wherein the narrow band LTE system is an in-band system.

8. The method of claim 5, wherein the information related to the PRB index is received by a physical broadcast channel.

9. A base station transmitting a control signal to a terminal comprising:
a transceiver configured to transmit and receive a signal to and from the terminal; and
a controller configured to control to identify a PRB index of a physical resource block (PRB) in which a narrow band LTE system is located and transmit information related to the PRB index to the terminal,
wherein the PRB index is a PRB index of an LTE system.

10. The base station of claim 9, wherein the information related to the PRB index is 5 bits.

11. The base station of claim 9, wherein the narrow band LTE system is an in-band system.

12. The base station of claim 9, wherein the information related to the PRB index is transmitted to a physical broadcast channel.

13. A terminal receiving a control signal from a base station, comprising:
a transceiver configured to transmit and receive a signal to and from the base station; and
a controller configured to control to receive information related to a PRB index of a physical resource block (PRB) in which a narrow band LTE system is located and identify the PRB index based on the information related to the PRB index,
wherein the PRB index is a PRB index of an LTE system.

14. The terminal of claim 13, wherein the information related to the PRB index is 5 bits.

15. The terminal of claim 13, wherein the narrow band LTE system is an in-band system.

16. The terminal of claim 13, wherein the information related to the PRB index is received by a physical broadcast channel.
